(19) United States
(12) Patent Application Publication
(10) Pub. No.: US 2011/0194008 A1
(43) Pub. Date: Aug. 11, 2011

(54) PHOTOGRAPHING APPARATUS

(75) Inventor: Chi-hun Hwang, Yongin-si (KR)

(73) Assignee: Samsung Electronics Co., Ltd., Suwon-si (KR)

(21) Appl. No.: 13/017,253

(22) Filed: Jan. 31, 2011

(30) Foreign Application Priority Data
Feb. 9, 2010 (KR) 10-2010-0012021

(51) Int. Cl. H04N 5/225; H04N 5/335

(52) U.S. Cl. 348/308; 348/340; 348/E05.091; 348/E05.024

(57) ABSTRACT

Provided is a photographing apparatus capable of completely removing dust from a surface of an image pickup unit mounted in the photographing apparatus. The photographing apparatus includes: a lens unit comprising a plurality of lenses; an image pickup unit that receives image light from the lens unit to form the image light into an image; a filter disposed on a side of the image pickup unit; a first vibration generating unit that is coupled to a first side of the filter; and a second vibration generating unit that is coupled to a second side of the filter opposite to the first side.

### CROSS-REFERENCE TO RELATED PATENT APPLICATION

This application claims the benefit of Korean Patent Application No. 10-2010-0012021, filed on Feb. 9, 2010, in the Korean Intellectual Property Office, the entire disclosure of which is incorporated herein by reference.

### BACKGROUND

1. Field of the Invention

The invention relates to a photographing apparatus, and more particularly, to a photographing apparatus capable of removing dust from a surface of a filter mounted in the photographing apparatus.

2. Description of the Related Art

Digital image photographing apparatuses such as digital cameras, digital camcorders, etc. for photographing images include an image pickup unit, e.g., a charge coupled device (CCD) sensor, a complementary metal oxide semiconductor (CMOS) sensor, or the like. The image pickup unit corresponds to a film of analog cameras, and if dust is on a surface of the image pickup unit, it adversely affects quality of a captured image. Thus, the dust on the surface of the image pickup unit needs to be removed before photographing.

### SUMMARY

Therefore there is a need in the art for a photographing apparatus comprising: a lens unit comprising a plurality of lenses; an image pickup unit that receives image light from the lens unit to form the image light into an image; a filter disposed on a side of the image pickup unit; a first vibration generating unit that is coupled to a first side of the filter; and a second vibration generating unit that is coupled to a second side of the filter, opposite to the first side.

The first vibration generating unit and the second vibration generating unit may be each coupled to a plane that is perpendicular to an image pickup surface of the image pickup unit.

The first vibration generating unit and the second vibration generating unit may cause the filter to vibrate.

The first vibration generating unit and the second vibration generating unit may comprise piezoelectric ceramics.

The first vibration generating unit and the second vibration generating unit may comprise piezoelectric ceramics having an azimuth angle of 45 degrees.

A first vibration may be generated and applied to the filter in a direction at 45 degrees by applying a current having a first frequency to the first vibration generating unit.

A second vibration may be generated and applied to the filter in a direction at 45 degrees by applying a current having a second frequency that is higher than the first frequency to the second vibration generating unit.

The first and second vibrations may be synthesized to be applied to the filter as a combination vibration.

The filter may be a low pass filter.

A flexible printed circuit board (FPCB) that transmits signals to the first vibration generating unit and the second vibration generating unit may be attached to the first vibration generating unit and the second vibration generating unit.

The first vibration generating unit and the second vibration generating unit and the FPCB may be coupled to each other using an anisotropic conductive tape.

The image pickup unit may comprise a charge couple device (CCD) sensor or a complementary metal oxide semiconductor (CMOS) sensor.

The photographing apparatus may be a single-lens reflex camera to which the lens unit is detachably mounted.

The photographing apparatus may be a compact camera.

A method of removing dust from a filter of a photographing apparatus wherein the filter is disposed between a lens and an image pickup unit is disclosed. The method may include generating a first vibration applied to a first side of the filter in response to a current having a first frequency; and generating a second vibration applied to a second side of the filter in response to a current having a second frequency.

The first vibration may be applied to the first side of the filter in a direction at approximately 45 degrees.

The second vibration may be applied to the second side of the filter in a direction at approximately 45 degrees.

The first vibration and the second vibration may each generated on a plane that is approximately perpendicular to an image pickup surface of the image pickup unit.

The first vibration and the second vibration may be generated as a combination vibration applied to the filter.

The first vibration and the second vibration may be generated using piezoelectric ceramics.

### BRIEF DESCRIPTION OF THE DRAWINGS

The above and other features and advantages of the invention will become more apparent by describing in detail exemplary embodiments thereof with reference to the attached drawings in which:

FIG. 1 is a perspective view illustrating a photographing apparatus according to an embodiment of the invention;

FIG. 2 is a cross-sectional view illustrating an inner configuration of the photographing apparatus of FIG. 1;

FIG. 3 is a dissembled perspective view illustrating components for removing dust in the photographing apparatus of FIG. 1;

FIG. 4 is a perspective view of the components for removing dust in the photographing apparatus of FIG. 1, which are to be coupled to each other;

FIG. 5 is a graph showing a first vibration curve generated in a first vibration generating unit of the photographing apparatus of FIG. 1;

FIG. 6 is a graph showing a second vibration curve generated in a second vibration generating unit of the photographing apparatus of FIG. 1; and

FIG. 7 is a graph showing a combination vibration curve formed by synthesizing the first and second vibration curves.

### DETAILED DESCRIPTION

The invention will now be described more fully with reference to the accompanying drawings, in which exemplary embodiments of the invention are shown.

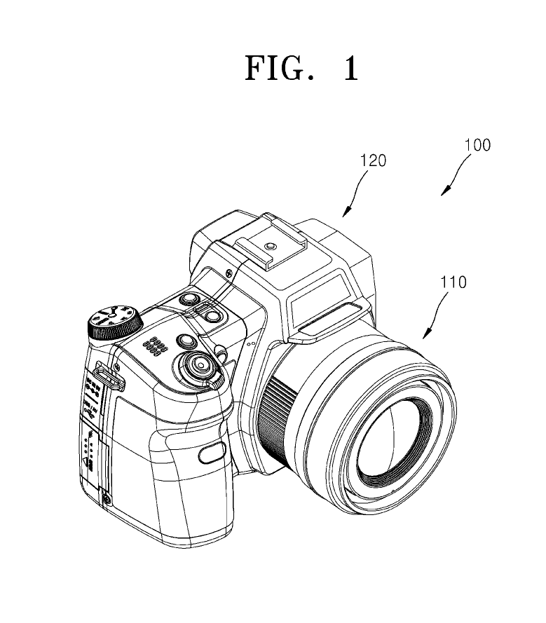

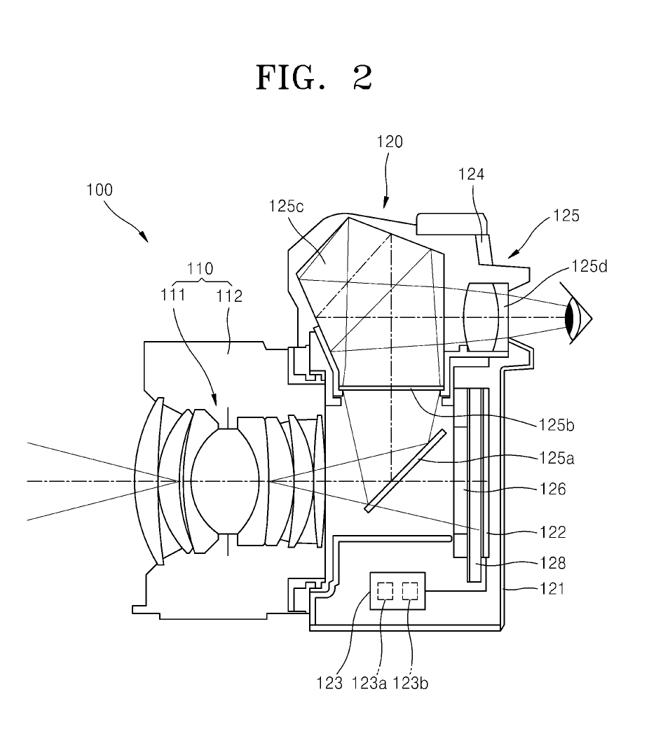

FIG. 1 is a perspective view illustrating a photographing apparatus 100 according to an embodiment of the invention, and FIG. 2 is a cross-sectional view illustrating an inner configuration of the photographing apparatus 100.

The photographing apparatus 100 is a single-lens reflex camera, a digital camera on which a lens unit is detachably mounted.

The photographing apparatus 100 includes a lens unit 110 and a main body 120.

The lens unit 110 includes a lens group 111 and a lens frame 112 where image light of incident to a subject passes through the lens group 111 and into the main body 120. The lens group 111 includes, for example, a plurality of optical lenses and an aperture, and is mounted on the lens frame 112.

The main body 120 includes a case 121, an image pickup unit 122, a control unit 123, a display unit 124, a view finder 125, a shutter assembly 126, and a filter 128.

The case 121 is formed of a synthetic resin or metal, etc. and functions as a frame of the main body 120.

The image pickup unit 122 is disposed at a position where the image light that passes through the lens unit 110 is formed into an image, to thereby convert the formed image into an electrical signal. The image pickup unit 122 is a photoelectric conversion device, and may be, for example, a charge coupled device (CCD) sensor. Another example of the image pickup unit 122 is a complementary metal oxide semiconductor (CMOS) sensor. Other types of image pickup devices may be used.

A filter 128 is disposed on a side of the image pickup unit 122. The filter 128 may be, for example, a high pass filter that passes only high frequencies and blocks low frequencies, a low pass filter that passes only low frequencies and blocks high frequencies, a band pass filter that passes only a predetermined frequency and blocks all other frequencies, a band rejection filter that blocks only a predetermined frequency but passes all other frequencies, or an all pass filter that passes all frequencies equally, but changes the phase relationship between various frequencies. According to the current embodiment of the invention, the filter 128 is described as an optical unit disposed on one side of the image pickup unit 122; however, the invention is not limited thereto, and the optical unit may also be, for example, a lens or a glass substrate.

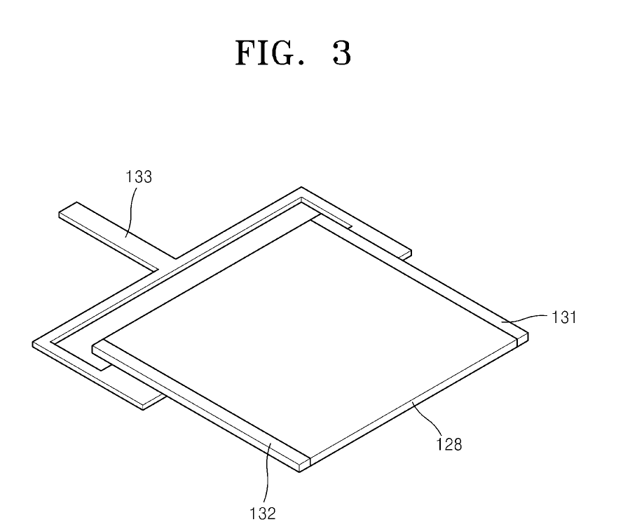

A characteristic of the invention is that first and second vibration generating units 131 and 132 (see FIG. 3) are disposed on two sides of the filter 128 to remove dust from the image pickup unit 122 of the photographing apparatus 100. The first and second vibration generating units 131 and 132 will be described in detail later with reference to FIGS. 3 through 7.

The control unit 123 is electrically connected to the image pickup unit 122, and performs key functions such as photographing of a subject, controlling of the image pickup unit 122, an image processing function, and a memory function.

The image processing function of the control unit 123 is performed using an image processing unit 123a. The image processing unit 123a converts an analog signal of an image received from the image pickup unit 122 into a digital signal, and performs gamma correction on the digital signal and signal processing to store the digital signal.

The memory function of the control unit 123 is performed using a memory 123b. The memory 123b stores captured images and operation programs of the photographing apparatus 100. To this end, the memory 123b may be a semiconductor memory device such as a synchronous dynamic random access memory (SDRAM).

According to the current embodiment of the invention, the control unit 123 includes the image processing unit 123a and the memory 123b but the invention is not limited thereto. That is, the image processing unit 123a and the memory 123b may also be separated from the control unit 123. The memory 123b may be a card-type portable memory for separately storing captured images.

The display unit 124 displays state information of the photographing apparatus 100. That is, the display unit 124 may be a liquid crystal display (LCD) and may display state information of the photographing apparatus 100. The display unit 124 is a LCD but the invention is not limited thereto. That is, the display unit 124 may be an organic light-emitting diode (OLED), a field emission display (FED), or the like.

According to the current embodiment, the display unit 124 does not have a function of displaying an image being captured, but the invention is not limited thereto. That is, the display unit 124 may display not only the state information of the photographing apparatus 100 but also an image being captured or a captured image.

The view finder 125 changes a path of light that is transmitted through the lens unit 110 and provides the light to the user so that the user may view a subject while photographing the subject using the photographing apparatus 100.

The view finder 125 includes a mirror 125a that is disposed on a light path along which image light that passes through the lens unit 110 travels and changes a path of the image light, a focal point screen 125b that adjusts a focal point of the image light that is changed using the mirror 125a, a prism 125c that changes a path of the image light that is transmitted through the focal point screen 125b, and an ocular lens 125d that receives image light that passes through the prism 125c and then the image light passes through the ocular lens 125d and may be viewed by the user (illustrated as an eye in FIG. 2).

The prism 125c illustrated in FIG. 2 is a pentagonal prism, which causes image light transmitted through the focal point screen 125b to proceed approximately perpendicularly so that the image light proceeds toward the ocular lens 125d that is disposed on a rear surface of the main body 120 of the photographing apparatus 100.

According to the current embodiment of the invention, the view finder 125 is designed such that an image formed on the image pickup unit 122 and an image displayed through the view finder 125 are the same but the invention is not limited thereto. That is, the image formed on the image pickup unit 122 and the image displayed through the view finder 125 may not be the same as there are many other possible designs for the view finder 125.

Hereinafter, components used to remove dust in the photographing apparatus 100, according to an embodiment of the invention, will be described in detail.

FIG. 3 is a dissembled perspective view illustrating components for removing dust in the photographing apparatus 100 of FIG. 1, and FIG. 4 is a perspective view of the components for removing dust in the photographing apparatus of FIG. 1, which are to be coupled to each other.

Referring to FIGS. 3 and 4, for dust removal, the photographing apparatus 100 further includes a first vibration generating unit 131 and a second vibration generating unit 132.

This will be described in more detail below.

According to the conventional art, a vibration generating unit is disposed on an upper or lower surface of a filter to remove dust in a photographing apparatus. In this case, the larger an image pickup unit and a filter, the more the size of the vibration generating unit also has to be increased, but it is difficult to manufacture a large-size vibration generating unit. Also, since a surface ratio of the vibration generating unit to the entire surface of the filter is high, the cost of the vibration generating unit and filter increases with the increased sizes of the image pickup unit and filter. Also, UV bonding is conducted on the upper surface of the filter or on the entire filter to couple the filter to the vibration generating unit, and thus a surface foreign substance defect ratio due to foreign substances on the filter is high. Furthermore, if defects are generated due to UV bonding, it is very difficult to replace the filter and the vibration generating unit, thus increasing the maintenance and repair costs. Also, as the vibration generating unit is attached on the upper surface of the filter, very high durability is required of the filter.

To solve this problem, according to the current embodiment of the invention, a vibration generating unit is attached not on an upper surface or a lower surface of a filter but on two sides of the filter.

In detail, the first vibration generating unit 131 and the second vibration generating unit 132 are respectively disposed on two sides of the filter 128 disposed on the side of the image pickup unit 122 (see FIG. 2). Also, a flexible printed circuit board (FPCB) 133 that transmits a signal to the first vibration generating unit 131 and the second vibration generating unit 132 is attached to the first vibration generating unit 131 and the second vibration generating unit 132.

The first vibration generating unit 131 and the second vibration generating unit 132 may be formed of piezoelectric ceramics. Piezoelectric ceramics generate a voltage when a pressure is applied thereto, and mechanical deformation is generated in the piezoelectric ceramics when an electric field is applied to the piezoelectric ceramics. The piezoelectric ceramics are capable of converting mechanical vibration energy into electrical energy or electrical energy into mechanical vibration energy, and conversion efficiency thereof is very high. In detail, lead titanate zirconate [Pb(Zr.Ti)O₃] is an example of a ferroelectric material that has a peroskite crystalline structure that shows significantly large piezoelectric characteristics among various piezoelectric ceramics. The basic composition of lead titanate zirconate is generally lead titanate (PbTiO₃) and lead zirconate (PbZrO₃), and characteristics thereof, such as piezoelectric dielectric elasticity, may be controlled by adjusting the combination ratio of these two components. Also, lead titanate zirconate is relatively stable in regard to ambient environments, and shows no particular change except a Curie point at around 300 C. Recently, a piezoelectric ceramic material having a temperature coefficient that is equal to crystal has been developed.

The first vibration generating unit 131 and the second vibration generating unit 132 are coupled to the filter 128 in the following manner.

First, the first vibration generating unit 131 and the second vibration generating unit 132 are coupled to the FPCB 133. The first vibration generating unit 131 and the second vibration generating unit 132 and the FPCB 133 are coupled using an adhesive member 134 such as an anisotropic conductive tape. Next, the first vibration generating unit 131 and the second vibration generating unit 132 coupled to the FPCB 133 are attached to two sides of the filter 128 by using, for example, UV bonding.

As described above, as two vibration generating units are respectively attached to two sides of the filter, space for coupling a vibration generating unit on an upper surface of the filter is not required, thereby minimizing a surface of the filter. Also, the surface area of the vibration generating units is minimized, and accordingly, an adhesion surface between the vibration generating units and the FPCB 133 is also reduced.

Hereinafter, a mechanism whereby dust is removed in the photographing apparatus 100 according to an embodiment of the invention will be described.

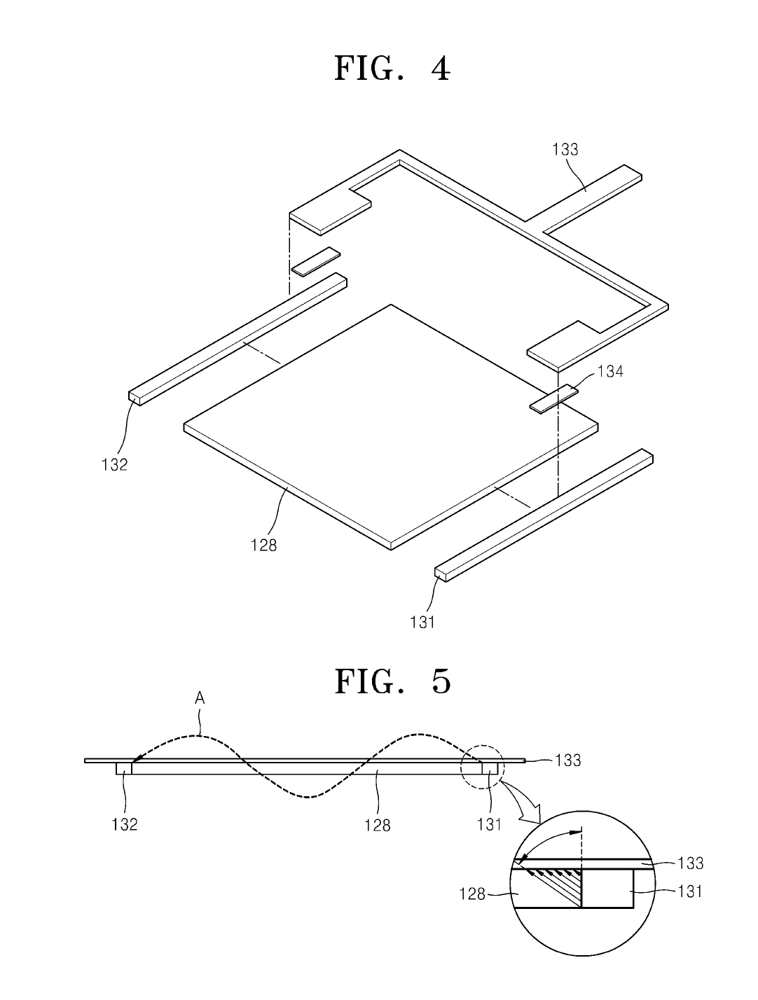

As illustrated in FIG. 5, the first vibration generating unit 131 is formed of piezoelectric ceramics having an azimuth angle of approximately 45 degrees. The first vibration generating unit 131 is coupled to a right side of the filter 128, and a predetermined current (having a first low frequency) is applied to the first vibration generating unit 131, thereby generating a vibration in the filter 128 at approximately 45 degrees. This is referred to as a first Sin vibration curve (arrow A in FIG. 5). The vibration generated on a plane of the filter 128 as described above is applied over a wide area but when the filter 128 is formed of glass as above, and if the glass is a narrow glass having a predetermined thickness, less vibration is generated on the plane of the filter 128 than on the sides of the filter 128. That is, in order to maximize a vibration rate on a flat glass substrate, an azimuth angle of approximately 45 degrees is required.

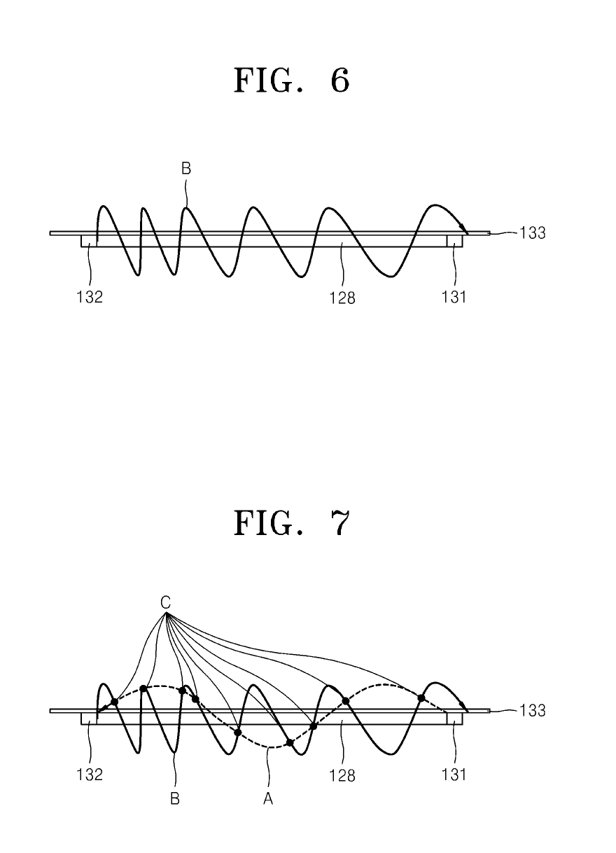

Meanwhile, as illustrated in FIG. 6, the second vibration generating unit 132 is formed of piezoelectric ceramics having an azimuth angle of approximately 45 degrees. The second vibration generating unit 132 is coupled to a left side of the filter 128, and a predetermined current (having a predetermined high frequency) is applied to the second vibration generating unit 132, thereby generating vibration in the filter 128 at approximately 45 degrees. This is referred to as a second Sin vibration curve (arrow B in FIG. 6).

A combination vibration curve (arrow C in FIG. 7) is formed by synthesizing the first and second Sin vibration curves.

According to the invention, since a vibration is generated on sides of the filter, the size of the vibration generating units may be minimized, thereby reducing the manufacturing costs. Also, as the vibration generating units are bonded not on a top surface of the filter but on the sides of the filter, defects due to the bonding may be significantly reduced. Also, since side bonding is conducted instead of upper surface bonding, the manufacturing costs are further reduced. Also, the components for removing dust are not stacked in an optical axis direction of a lens, and thus space in a camera may be efficiently used.

According to the invention, components of the photographing apparatus for removing dust are light and compact, and dust on a surface of the image pickup unit may be completely removed by vibrating a filter mounted on a side of the image pickup unit.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A photographing apparatus comprising:
a lens unit comprising a plurality of lenses;
an image pickup unit configured to receive image light that passes through the lens unit and generate electrical signals from the received image light;
a filter disposed on a side of the image pickup unit;
a first vibration generating unit that is coupled to a first side of the filter; and
a second vibration generating unit that is coupled to a second side of the filter, the second side being opposite to the first side.

2. The photographing apparatus of claim 1, wherein the first vibration generating unit and the second vibration generating unit are each coupled to a plane that is approximately perpendicular to an image pickup surface of the image pickup unit.

3. The photographing apparatus of claim 1, wherein the first vibration generating unit and the second vibration generating unit are configured to cause the filter to vibrate.

4. The photographing apparatus of claim 1, wherein the first vibration generating unit and the second vibration generating unit comprise piezoelectric ceramics.

5. The photographing apparatus of claim 4, wherein the first vibration generating unit and the second vibration generating unit comprise piezoelectric ceramics having an azimuth angle of approximately 45 degrees.

6. The photographing apparatus of claim 4, wherein the first vibration generating unit is configured to generate a first vibration applied to the filter in a direction at approximately 45 degrees in response to a current having a first frequency being applied to the first vibration generating unit.

7. The photographing apparatus of claim 6, wherein the second vibration generating unit is configured to generate a second vibration applied to the filter in a direction at approximately 45 degrees in response to a current having a second frequency being applied to the second vibration generating unit.

8. The photographing apparatus of claim 7, wherein the first and second vibrations are synthesized as applied to the filter to be a combination vibration.

9. The photographing apparatus of claim 1, wherein the filter is a low pass filter.

10. The photographing apparatus of claim 1, wherein a flexible printed circuit board (FPCB) that transmits signals to the first vibration generating unit and the second vibration generating unit are attached to the first vibration generating unit and the second vibration generating unit.

11. The photographing apparatus of claim 10, wherein the first vibration generating unit and the second vibration generating unit and the FPCB are coupled to each other using an anisotropic conductive tape.

12. The photographing apparatus of claim 1, wherein the image pickup unit comprises a charge couple device (CCD) sensor or a complementary metal oxide semiconductor (CMOS) sensor.

13. The photographing apparatus of claim 1, wherein the photographing apparatus is a single-lens reflex camera to which the lens unit is detachably mounted.

14. The photographing apparatus of claim 1, wherein the photographing apparatus is a compact camera.

15. A method of removing dust from a filter of a photographing apparatus, wherein the filter is disposed between a lens and an image pickup unit, the method comprising:
generating a first vibration applied to a first side of the filter in response to a current having a first frequency; and
generating a second vibration applied to a second side of the filter in response to a current having a second frequency.

16. The method of claim 15, wherein the first vibration is applied to the first side of the filter in a direction at approximately 45 degrees.

17. The method of claim 15, wherein the second vibration is applied to the second side of the filter in a direction at approximately 45 degrees.

18. The method of claim 15, wherein the first vibration and the second vibration are each generated on a plane that is approximately perpendicular to an image pickup surface of the image pickup unit.

19. The method of claim 15, wherein the first vibration and the second vibration are generated as a combination vibration applied to the filter.

20. The method of claim 15, wherein the first vibration and the second vibration are generated using piezoelectric ceramics.
